(19) United States
(12) Patent Application Publication
(10) Pub. No.: US 2010/0079109 A1
(43) Pub. Date: Apr. 1, 2010

(54) METHODS AND APPARATUS FOR STORING ELECTRICITY

(75) Inventors: Thor E. Eilertsen, Oneonta, NY (US); Daniel A. Patsos, Otego, NY (US)

Correspondence Address: COOLEY GODWARD KRONISH LLP;ATTN: Patent Group, Suite 1100, 777 - 6th Street, NW, WASHINGTON, DC, 20001, US

(73) Assignee: loxus, Inc., Oneonta, NY (US)

(21) Appl. No.: 12/570,435

(22) Filed: Sep. 30, 2009

Related U.S. Application Data
(60) Provisional application No. 61/101,438, filed on Sep. 30, 2008.
(60) Provisional application No. 61/122,867, filed on Dec. 16, 2008.

(51) Int. Cl. H02J 7/00

(52) U.S. Cl. 320/127; 320/166

(57) ABSTRACT

In some embodiments, a system includes a battery and a capacitor bank. The battery is electrically coupled to a load device and is configured to supply power to the load device when the system is in a first configuration. The system is in the first configuration when a current requirement of the load device is less than a current threshold. The capacitor bank includes a plurality of capacitors and is electrically coupled to the battery when the system is in a second configuration. The battery and the capacitor bank are configured to collectively provide power to the load device when the system is in the second configuration. The system is in the second configuration when the current requirement of the load device is greater than the current threshold.

### RELATED APPLICATIONS

This application claims priority to, and the benefit of U.S. Provisional Patent Application Ser. No. 61/101,438, filed on Sep. 30, 2008, and entitled “Electricity Storage,” and U.S. Provisional Patent Application Ser. No. 61/122,867, filed on Dec. 16, 2008, and entitled “Electricity Storage,” each of which is incorporated herein by reference in its entirety.

### BACKGROUND

Embodiments described herein relate generally to storing electricity and more particularly, to storing electricity using electric double layer capacitors (EDLCs).

Electric motors are currently used in a variety of devices. For example, electric vehicles such as, automobiles, golf carts, forklifts, and the like can use electric motors. Such devices often require a large amount of power. Such large power requirements can quickly drain the battery and limit the amount of time a battery can power the device before the battery must be recharged or replaced. Accordingly, operators of such devices must often recharge and/or replace the batteries in such devices.

Further, known devices often require higher than normal power for periods of time during operation. For example, a forklift can require additional power when lifting a heavy load. Such additional power can strain the battery supplying power to the load, which can shorten the effective life of the battery. Such repeated strains can quickly drain the battery and reduce the amount of time the battery can power the device before the battery must be recharged or replaced.

Thus, a need exists for a power system that can provide power to electric motors for longer periods of time than the known power systems such that electric motors can be operated for longer periods of time between recharging and/or replacing a battery. Additionally, a need exists for a power system that can supply increased power to electric motors during periods of high power demand.

### SUMMARY

In some embodiments, a system includes a battery and a capacitor bank. The battery is electrically coupled to a load device and is configured to supply power to the load device when the system is in a first configuration. The system is in the first configuration when a current requirement of the load device is less than a current threshold. The capacitor bank includes a plurality of capacitors and is electrically coupled to the battery when the system is in a second configuration. The battery and the capacitor bank are configured to collectively provide power to the load device when the system is in the second configuration. The system is in the second configuration when the current requirement of the load device is greater than the current threshold.

### BRIEF DESCRIPTION OF THE DRAWINGS

FIG. 1A is a schematic illustration of a power system, according to an embodiment.

FIG. 1B is a state diagram illustrating the operation of a control system of a power system controller, according to another embodiment.

FIG. 2 is a perspective view of a portion of a power system, according to another embodiment.

FIG. 3 is a schematic illustration of the portion of the power system shown in FIG. 2.

FIG. 4A is a side view of a bus bar, according to another embodiment.

FIG. 4B is a perspective exploded view of the bus bar shown in FIG. 4A.

FIGS. 5A-5J illustrate assembling a capacitor bank using bus bars, according to another embodiment.

FIG. 6 is a perspective view of a capacitor bank, according to another embodiment.

FIG. 7A is a perspective view of a capacitor bank within a housing of a power system, according to another embodiment.

FIG. 7B is a top view of the capacitor bank of FIG. 7A within a housing of a power system.

FIG. 8 is a flow chart illustrating a method of controlling a power system, according to another embodiment.

### DETAILED DESCRIPTION

In some embodiments, a system includes a battery and a capacitor bank. The battery is electrically coupled to a load device and is configured to supply power to the load device when the system is in a first configuration. The system is in the first configuration when a current requirement of the load device is less than a current threshold. In some embodiments, the current threshold can be equal to the maximum amount of current that can be delivered to the load device without straining the battery (e.g., excessive current drain, shortening the life of the battery, etc.). The capacitor bank includes a plurality of capacitors and is electrically coupled to the battery when the system is in a second configuration. The battery and the capacitor bank are configured to collectively provide power to the load device when the system is in the second configuration. The system is in the second configuration when the current requirement of the load device is greater than the current threshold.

In some embodiments, the capacitor bank includes multiple electric double layer capacitors (EDLCs) arranged in serial and/or parallel configurations. In such embodiments, the capacitors in the capacitor bank can be charged by the battery when a voltage associated with the capacitor bank is less than a voltage threshold (e.g., less than a voltage of the battery). In some embodiments, a controller can monitor the voltage associated with the capacitor bank, the current requirement of the load device and/or a voltage associated with the battery.

In some embodiments, a processor-readable medium stores code representing instructions configured to cause a processor to electrically isolate a capacitor bank of a system from a load device of the system when the system is in a first configuration, electrically couple the capacitor bank to the load device when the system is in a second configuration, and electrically couple the capacitor bank with a battery such that the battery charges the capacitor bank when the system is in a third configuration. The battery provides power to the load device when the system is in the first configuration. The system is in the first configuration when a current requirement of the load device is less than a current threshold. The battery and the capacitor bank collectively provide power to the load device when the system is in the second configuration. The system is in the second configuration when a current requirement of the load device is greater than a current threshold. The system is in the third configuration when a voltage associated with the capacitor bank is less than a voltage associated with the battery.

As used herein, “electrically isolated” can mean not electrically coupled to, unable to provide current and/or power to, not part of a complete circuit (e.g., not part of a common current loop), and/or the like. For example, if a first system is electrically isolated from a second system, the first system cannot provide current and/or power to the second system and/or the first system is not part of a complete circuit with the second system. For another example, a capacitor bank can be electrically isolated from a battery if the capacitor bank is not coupled to either terminal of the battery or is only coupled to a single terminal of the battery. Accordingly, two systems can be electrically isolated from each other even though they share an electrical connection (e.g., a common ground connection) if the electrical connection does not enable the first system to provide current and/or power to the second system (or vice versa) and/or does not create a common current loop between the systems.

As used herein, “electrically coupled” can mean not electrically isolated, able to provide current and/or power to, part of a complete circuit (e.g., part of a common current loop) and/or the like. For example, if a first system is electrically coupled to a second system, the first system can provide current and/or power to the second system and/or the first system is part of a complete circuit with the second system. For another example, a capacitor bank can be electrically coupled to a battery when the capacitor bank is coupled to both terminals of the battery. This creates a common current loop between the battery and the capacitor bank. Similarly, a battery can charge the capacitor bank when the battery is electrically coupled to the capacitor bank. Further, the battery and/or the capacitor bank can provide power and/or current to a load device when the battery and/or the capacitor bank is electrically coupled to the load device.

As used in this specification, the singular forms “a,” “an” and “the” include plural referents unless the context clearly dictates otherwise. Thus, for example, the term “a battery” is intended to mean a single battery or a combination of batteries; and “capacitor” is intended to mean one or more capacitors, or a combination thereof.

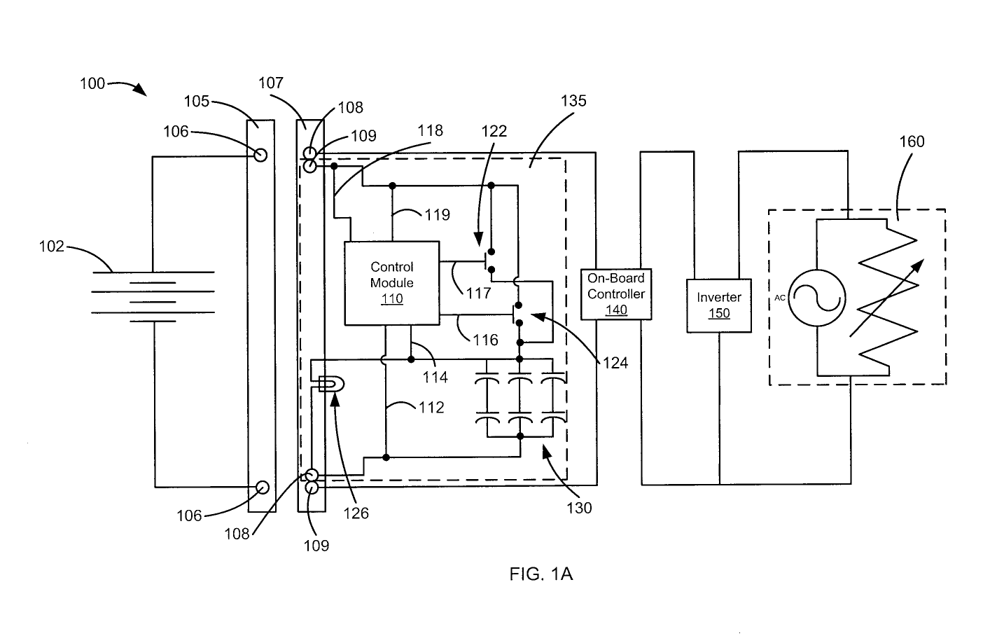

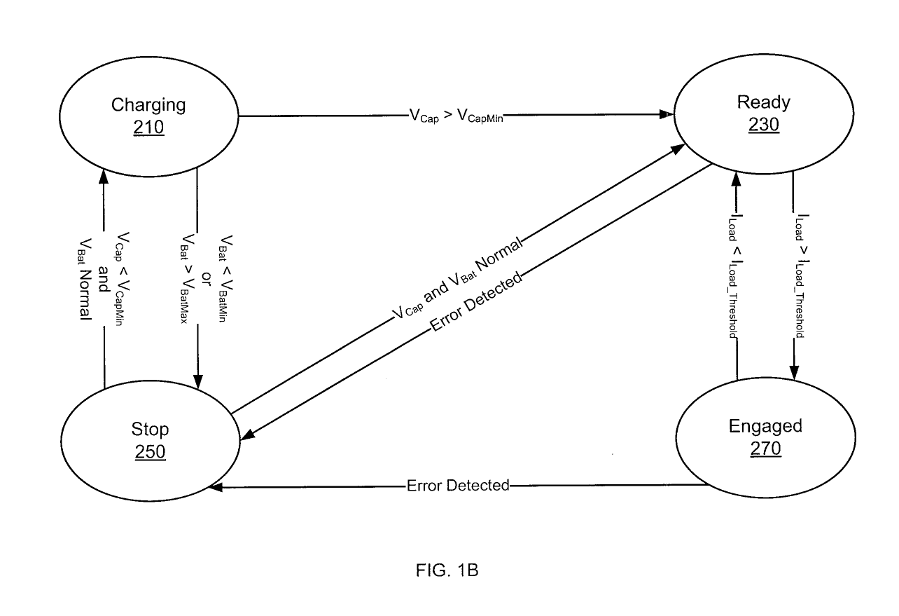

FIG. 1A is a schematic illustration of a power system 100, according to an embodiment. The system 100 includes a battery 102, a first connector 105, a second connector 107, a capacitor system 135, an on-board controller 140, an inverter 150 and a load 160. The load 160 can be any suitable device requiring power, for example, an electric motor. In some embodiments, for example, the power system 100 is configured to provide power to a forklift. In other embodiments, the power system 100 can provide power to automobiles, golf carts, and/or the like.

The battery 102 can be any suitable battery. In some embodiments, for example, the battery 102 is a conventional lead-acid battery. In other embodiments, the battery can be a lithium-ion battery, a nickel-cadmium battery, an alkaline battery and/or the like. The battery 102 is configured to be the main power source to the load 160.

The battery 102 is electrically coupled to the load 160 via a first electrical connector 105 and a second electrical connector 107. The electrical connector 105 includes multiple outlets 106. The outlets 106 are configured to couple to outlets 108, 109 of the second electrical connector 107. The outlets 106, 108, 109 can be configured such that outlet 108 and outlet 109 of the second electrical connector 107 both couple to outlet 106. Further, outlet 108 can be electrically coupled to outlet 109 via outlet 106. Accordingly, outlet 108 is electrically isolated from outlet 109 when the outlets 108, 109 are not physically coupled to outlet 106. This configuration electrically isolates the capacitor system 135 from the load 160 when the battery 102 is electrically isolated from the load 160, as described in further detail herein.

The electrical connectors 105, 107 can be any suitable electrical connectors. In some embodiments, for example, the electrical connectors 105, 107 can be Anderson connectors that are modified such that the outlets 108, 109 of connector 107 both physically connect to the outlet 106 of the connector 105. Such modification allows the modified Anderson connector 107 to plug directly into existing commercially available connectors that can be included with the battery 102. Such Anderson connectors can be connectors commercially available from Anderson Power Products of Massachusetts or other companies. In other embodiments, other connectors can be used.

The electrical connectors 105, 107 can include any suitable contacts and terminations. In some embodiments, for example, the electrical connectors 105, 107 include flat-wiping contracts, pin and socket contacts, hot pluggable contacts, make-first/break-last contacts, mixed power and signal contacts, and/or the like. In some embodiments, the electrical connectors 105, 107 can include bus bar terminations, printed circuit board (PCB) terminations, panel terminations, cable mounting application terminations, and/or the like. In some embodiments, the electrical connectors 105, 107 have ratings from 5 to 700 amps for 150 volts to 600 volts. In some embodiments, the electrical connectors can be used for alternating current (AC) or direct current (DC) applications.

In other embodiments, the electrical connectors can be any other standard connector. Using standard connectors, such as an Anderson connectors, the power system 100 can easily and inexpensively be modified to contain a capacitor system 135. Such modification can be easily implemented by modifying the electrical connector 107 as described above.

The on-board controller 140 can be any suitable controller configured to monitor and supply power to the load 160. In some embodiments, for example, the on-board controller 140 can include a processor and a memory. In such embodiments, the on-board controller 140 can be fully programmable. For example, various current thresholds and/or voltage thresholds can be programmed such that the on-board controller 140 performs actions (e.g., shuts the system off, limits the voltage across the load 160, limits the current supplied to the load 160 and/or the like) when the thresholds are reached. Because the on-board controller 140 is programmable, such thresholds can be varied based on the load and/or the application. The inverter 150 can be any suitable inverter that converts the direct current (DC) supplied by the battery 102 and the capacitor system 135 into alternating current (AC) used to power the load 160.

The capacitor system 135 includes a control module 110, a first switch 122, a second switch 124, a capacitor bank 130, and a power indicator 126. In some embodiments, the capacitor system 135 can be referred to as an EDLC Enhanced Energy Conversion System or an EDLC Energy Reservoir System (EERS). The power indicator 126 can be any type of indicator that can provide a status indication to a user. In some embodiments, for example, the power indicator 126 can be one or more light emitting diodes (as shown in FIG. 1A), a display screen (e.g., a liquid crystal display (LCD)), a haptac indicator, an audible alarm and/or the like. In some embodiments, the power indicator 126 can provide an indication to a user that the capacitor bank 130 is charged, the capacitor system 135 is correctly coupled to the battery 102, an error has occurred, and/or the like.

The first switch 122 and the second switch 124 can be any switches configured to switch between an on position (allowing current to flow) and an off position (restricting current flow). For example, when a signal (e.g., a voltage above a voltage threshold) is supplied to the first switch 122 by the control module 110 via the electrical conductor 117, the switch can be moved from the off position to the on position. Similarly, when an opposite signal (e.g., a voltage below the voltage threshold, ground, etc.) is supplied to the first switch 122 by the control module via the electrical conductor 117, the switch can be moved from the on position to the off position. Similarly, the second switch 124 can be moved between its off position and its on position when the control module 110 supplies signals to the second switch 124 via the electrical conductor 116. The operation of the first switch 122 and the second switch 124 is described in further detail herein.

In some embodiments, the first switch 122 and/or the second switch 124 can be any electrical component configured to be switched between allowing current to flow and restricting current flow. For example, the switches 122, 124 can be transistors (e.g., metal oxide-semiconductor field-effect transistors (MOSFETs)), multiplexors, microcontrollers, and/or the like.

The capacitor bank 130 includes multiple capacitors arranged to provide a secondary power supply to the load 160. The capacitors can be, for example, electric double layer capacitors (EDLCs), pseudo electric double layer capacitors (PEDLCs), and/or the like. As shown in FIG. 1A, multiple capacitors can be electrically coupled in series to create a capacitor row. Each capacitor row can then be coupled in parallel to the other capacitor rows. In some embodiments, for example, the capacitor bank 130 can include capacitors similar to the capacitors shown and described in pending PCT Application No. PCT/US09/55299, filed Aug. 28, 2009, and entitled “High Voltage EDLC Cell and Method for the Manufacture Thereof,” which is incorporated herein by reference in its entirety.

In some embodiments, for example, a capacitor row can include 15 EDLCs coupled in series. Four capacitor rows can be coupled in parallel. In such embodiments, the capacitor bank 130 can have an upper limit of 40.5 VDC and a peak surge rating of 42.75 V. In other embodiments, the capacitors within the capacitor bank can be arranged in any configuration to meet any voltage and/or current requirement. For example, a capacitor row can include any number of capacitors and the capacitor bank can include any number of capacitor rows in parallel. Accordingly, the voltage and/or current supplied by the capacitor bank can be any suitable voltage and/or current based on the arrangement of the capacitors.

As discussed above, the capacitor bank 130 is electrically isolated from the battery 102 and the load 160 when the battery is electrically isolated from the load 160 (e.g., through connectors 105, 107, and/or through a disconnect sensing switch described in further detail herein). Further, as described in further detail herein, in various situations, using the first switch 122 and the second switch 124, the control module 110 can electrically isolate the capacitor bank 130 from the battery 102 and/or the load 160.

The control module 110 is an assembly of electrical components configured to control the operation of the capacitor system 135. In some embodiments, for example, the control module 110 includes a memory (not shown) and a processor (not shown). The memory can store code representing instructions configured to cause the processor to control the power system 135. In some embodiments, the control module 130 can be a microcontroller, a field programmable gate array (FPGA), a microprocessor, an application-specific integrated circuit (ASIC), a programmable logic device (PLD) and/or any other suitable combination of electronics. The control module 110 is disposed within a same housing as the capacitor bank 130 to reduce noise and/or parasitic capacitance in the capacitor system 135.

The control module 110 is powered by the battery via electrical conductor 119. In some embodiments, the control module 110 also includes a secondary battery (not shown) that provides power to the control module 110 when the control module 110 is electrically isolated from the battery 102. This allows the control module 110 to control the capacitor system 135 when the battery 102 is electrically isolated from the power system 100.

The control module 110 monitors the voltage at various nodes in the power system 100. For example, the control module 110 monitors the voltage across the battery 102 via the electrical conductor 118 and the voltage across the capacitor bank via the electrical conductor 114. The voltage measurements can be taken with reference to a system ground voltage. The control module 110 receives the system ground voltage via the electrical conductor 112. In other embodiments, other voltages are monitored and/or controlled within the system based on the specific application.

Additionally, the control module 110 monitors the current at various nodes in the power system 100. For example, the control module 110 monitors the total current required by the load 160, the current supplied by the battery 102 to the load 160, the current supplied by the battery 102 to the capacitor bank 130 (e.g., when charging the capacitor bank), and the current supplied by the capacitor bank 130 to the load 160. In other embodiments, other currents are monitored and/or controlled within the system based on the specific application.

In some embodiments, the power system 100 can also include a disconnect sensing switch (not shown in FIG. 1A) operatively coupled to the electrical connector 107. Such a disconnect sensing switch can be configured to sense when the battery 102 is disconnected from the power system 100. When such a disconnect is sensed, the disconnect sensing switch electrically isolates the capacitor system 135 from the load 160 such that the load 160 cannot be driven solely by the capacitor system 135.

FIG. 1B is a state diagram illustrating the operation of the control module 110. The control module 110 is configured to control the capacitor system 135 in four different states or configurations: a charging state 210, a ready state 230, a stop state 250 and an engaged state 270. In other embodiments, the control module can include any number of states or configurations corresponding to the functions of the control module.

When the capacitor system 135 is in the stop state 250, both the first switch 122 and the second switch 124 are in their off positions. Accordingly, current cannot pass through the first switch 122 or the second switch 124. This electrically isolates the capacitor bank 130 from the battery 102 and the load 160. Thus, the battery 102 cannot charge the capacitors in the capacitor bank 130 and the capacitor bank 130 cannot supply power to the load 160 when the capacitor system 135 is in the stop state 250.

When the capacitor system 135 is in the charging state 210, the battery 102 is configured to charge the capacitors in the capacitor bank 130. In some embodiments, this can be done by supplying a pulse width modulated (PWM) signal to the first switch 122. The PWM signal can switch the first switch 122 to its on position for a given amount of time (e.g., 30 seconds, 15 minutes, etc.) when the PWM signal is in its high state. During this time period, the battery 102 supplies current to the capacitor bank 130, charging the capacitors in the capacitor bank 130. The PWM signal can switch the first switch 122 to its off position for a given amount of time (e.g., 30 seconds, 15 minutes, etc.) when the PWM is in its low state. During this time period, the capacitor bank 130 is electrically isolated from the battery 102. A PWM signal provides a controlled charging current to the capacitor bank 130. This ensures that the battery 102 is not completely drained while charging the capacitor bank 130. For example, if the capacitor bank 130 is completely discharged, the battery's 102 positive terminal will be electrically coupled to its negative terminal, creating a short. With the PWM signal, this short will not last for an extended period of time, putting less stress on the battery 102.

In some embodiments, a current limiter (not shown in FIG. 1A) is disposed within the power system 100 between the battery 102 and the capacitor bank 130. The current limiter can limit the amount of current that the battery 102 can supply to the capacitor bank 130. For example, the current limiter can ensure that the current supplied to the capacitor bank 130 from the battery 102 is less than a charging current threshold. In such embodiments, when the capacitor bank 130 is completely discharged, the current limiter prevents the battery 102 from supplying all of its current to the capacitor bank 130. This allows the battery 102 to supply current to the load 160 while charging the capacitor bank 130. Accordingly, in such embodiments, the battery can charge the capacitor bank 130 while supplying power to the load 160.

In some embodiments, the load 160 can charge the capacitor bank 130 and/or the battery 102 using power regeneration. In such embodiments, for example, when the load 160 is performing an activity that does not require power from the power system, it can generate power and provide the regenerated power to the capacitor bank 130 and/or the battery 102. For example, if the load 160 is an electric automobile, when the automobile is coasting and/or breaking, power is not needed to drive the automobile. The rotation of wheels on the automobile during coasting and/or breaking can generate power to charge the capacitor bank 130 and/or the battery 102. For another example, if a lift on a forklift is being lowered, the lowering of the lift can generate power.

The capacitors in the capacitor bank 130 can quickly be charged using the regenerated power. In some embodiments, the regenerated power is initially supplied to the capacitors. After the capacitors are completely charged, the control module 110 can be configured to supply the regenerated power to the battery 102 until the battery 102 is completely charged.

When the capacitor system 135 is in the ready state 230, the capacitor bank 130 is charged and ready to provide additional current to the load 160 when needed. Both the first switch 122 and the second switch 124 are in their off positions when the power system is in the ready state 230.

When the capacitor system 135 is in the engaged state 270, the capacitor bank 130 and the battery 102 collectively provide current to the load 160. The second switch 124 is maintained in its on position while the capacitor system 135 is in the engaged state 270. Via the connectors 105, 107, the capacitor bank 130 is electrically coupled in parallel with the battery 102 and the load 160. Accordingly, both the capacitor bank 130 and the battery 102 provide current to the load 160 when the capacitor system 135 is in the engaged state 270. This reduces the demand on the battery 102 and prolongs the amount of time the power system 100 can supply power to the load 102 without recharging the battery 102. This also can prolong the life of the battery 102.

The control module 110 moves the capacitor system 135 from the stop state 250 to the charging state 210 when a voltage of the capacitor bank 130 (V_{Cap}) is less than a minimum voltage threshold of the capacitor bank 130 (V_{CapMin}) and the battery 102 is operating normally (e.g., does not have any errors). In some embodiments, the minimum voltage threshold of the capacitor bank 130 (V_{CapMin}) can be substantially equal to the voltage of the battery 102. In such embodiments, the control module 110 maintains the voltage of the capacitor bank 130 (V_{Cap}) substantially equal to the voltage of the battery 102. This ensures that the required voltage is supplied to the load 160 when the capacitor bank 130 and the battery 102 collectively supply power to the load 160 (e.g., in the engaged state 270). Additionally, in such embodiments, the voltage of the capacitor bank 130 (V_{Cap}) can vary with the voltage of the battery 102 as the voltage of the battery 102 slowly decreases over time.

The control module 110 moves the capacitor system 135 from the charging state 210 to the stop state 250 when errors are detected in the battery 102. For example, as shown in FIG. 1B, if the voltage of the battery 102 (V_{Bat}) is less than a minimum voltage threshold of the battery 102 (V_{BatMin}) or the voltage of the battery 102 (V_{Bat}) is greater than a maximum voltage threshold of the battery 102 (V_{BatMin}), the control system 110 moves the capacitor system 135 into the stop state 250. When the voltage of the battery 102 (V_{Bat}) is less than the minimum voltage threshold of the battery 102 (V_{BatMin}), the battery 102 likely does not have enough charge to charge the capacitor bank 130. When the voltage of the battery 102 (V_{Bat}) is greater than a maximum voltage threshold of the battery 102 (V_{BatMax}), the control system 110 moves the capacitor system 135 into the stop state 250 to protect the capacitor bank 130 from high voltage that can damage the capacitors in the capacitor bank 130.

The control module 110 moves the capacitor system 135 from the charging state 210 to the ready state 230 when the capacitors in the capacitor bank 130 are charged. As shown in FIG. 1B, this occurs when the voltage of the capacitor bank 130 (V_{Cap}) is greater than the minimum voltage threshold of the capacitor bank 130 (V_{CapMin}). As discussed above, once in the ready state, the capacitor system 135 is ready to provide power to the load 160 as needed.

The control module 110 moves the capacitor system 135 from the ready state 230 to the engaged state 270 when the load 160 needs additional power. The control module 110 monitors the current being supplied to the load 160 (I_{Load}) and compares this current with a current threshold at the load 160 (I_{Load}_{_{—}}_{Threshold}). When the current supplied to the load 160 (I_{Load}) is greater than a current threshold at the load 160 (I_{Load}_{_{—}}_{Threshold}), the control module 110 moves the capacitor system 135 from the ready state 230 to the engaged state 270. As discussed above, the control module 110 can move the capacitor system 135 to the engaged state 270 by supplying a signal to the second switch 124 that moves the second switch 124 to its on position.

The control module 110 moves the capacitor system 135 from the engaged state 270 to the ready state 230 when the load 160 no longer needs additional power. When the current supplied to the load 160 (I_{Load}) is less than the current threshold at the load 160 (I_{Load}_{_{—}}_{Threshold}), the control module 110 moves the capacitor system 135 from the engaged state 270 to the ready state 230. As discussed above, the control module 110 can move the capacitor system 135 to the ready state 230 by supplying a signal to the second switch 124 that moves the second switch 124 to its off position. As discussed above, this electrically isolates the capacitor bank 130 from the load 160 and the battery 102.

The control module 110 moves the capacitor system 135 from the ready state 230 to the stop state 250 when an error is detected in the power system 100. Similarly, the control module 110 moves the capacitor system 135 from the engaged state 270 to the stop state 250 when an error is detected in the power system 100. Errors detected by the control module 130 can include the voltage of the capacitor bank 130 (V_{Cap}) is less than a minimum voltage threshold of the capacitor bank 130 (V_{CapMin}), the voltage of the battery 102 (V_{Bat}) is less than a minimum voltage of the battery 102 (V_{BatMin}), the voltage of the battery 102 (V_{Bat}) is greater than a maximum voltage of the battery 102 (V_{BatMax}), the current of the battery (I_{Bat}) is less than a minimum current of the battery 102 (I_{BatMin}) and the current at the load 160 (I_{Load}) is greater than a maximum current at the load 160 (I_{LoadMax})_{, the current going into the capacitor bank 130 (I}_{Cap}) is greater than a maximum current threshold (I_{CapMax}) and/or the like. As discussed above, when in the stop state, the capacitor bank 130 is electrically isolated from the battery 102 and the load 160. In some embodiments and as described above, switches 122, 124 can be used to electrically isolate the capacitor bank 130 from the battery 102 and the load 160. This prevents damage to the capacitor bank 130 when errors are detected in the power system 100 (e.g., high voltage). Additionally, when the battery 102 is physically removed from the power system 100 (e.g., the electrical connector 105 is uncoupled from electrical connector 107), the capacitor system 135 is moved into the stop state 250. This prevents the power system 100 from powering the load 160 purely from the capacitor bank 130.

The control module moves the capacitor system 135 from the stop state 250 to the ready state 230 when the capacitor bank 130 is charged and the battery 102 is operating normally. This indicates that the voltage of the capacitor bank 130 (V_{Cap}) is greater than the minimum voltage threshold of the capacitor bank 130 (V_{CapMin}) and the voltage of the battery 102 (V_{Bat}) is within its normal operating parameters (V_{BatMin}<V_{Bat}<V_{BatMax}).

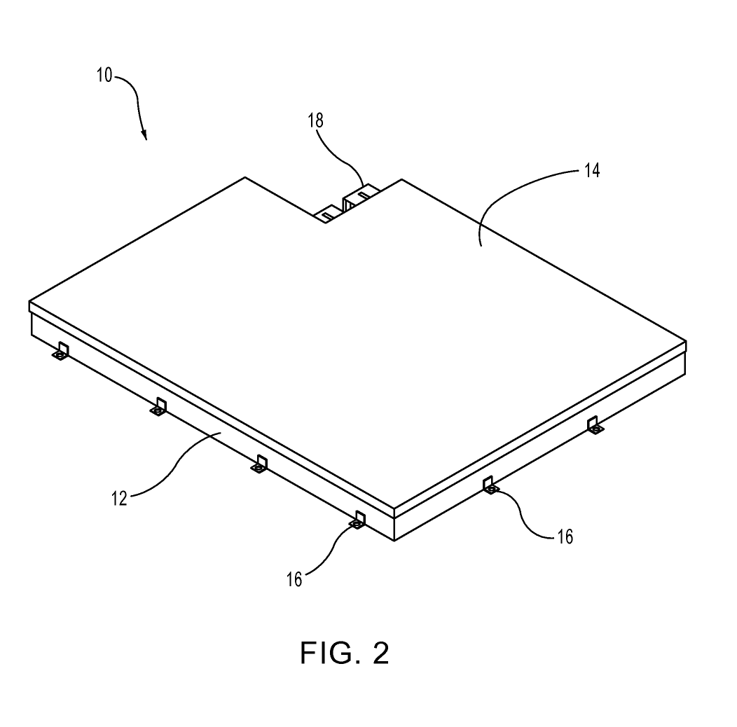

FIG. 2 illustrates an embodiment of a capacitor system 10, according to an embodiment. The capacitor system is configured to be coupled to a conventional battery (or batteries), such as, for example, a lead acid battery. The capacitor system 10 includes a housing 12 and a cover 14. After final assembly, the cover 14 can be permanently attached to the housing 12 to prevent tampering or can be easily removable to replace or repair broken or malfunctioning components. The housing 12 includes a plurality of mounting brackets 16 for securing the capacitor system 10 to a vehicle or a battery system. The capacitor system 10 also includes one or more connectors 18 (similar to the connectors 108, 109 shown and described in FIG. 1) that protrude through the housing to allow the capacitor system 10 to connect to and enhance the operation of the conventional battery/batteries. The capacitor system 10 design comes in a relatively small-footprint package that simply plugs directly into an existing or modified connector of the conventional battery/batteries. The capacitor system 10 can be an add-on system that enables an existing battery powered forklift truck, golf cart, or any other apparatus containing one or more electric motors and/or other electric devices to be quickly and easily upgraded to enhance performance.

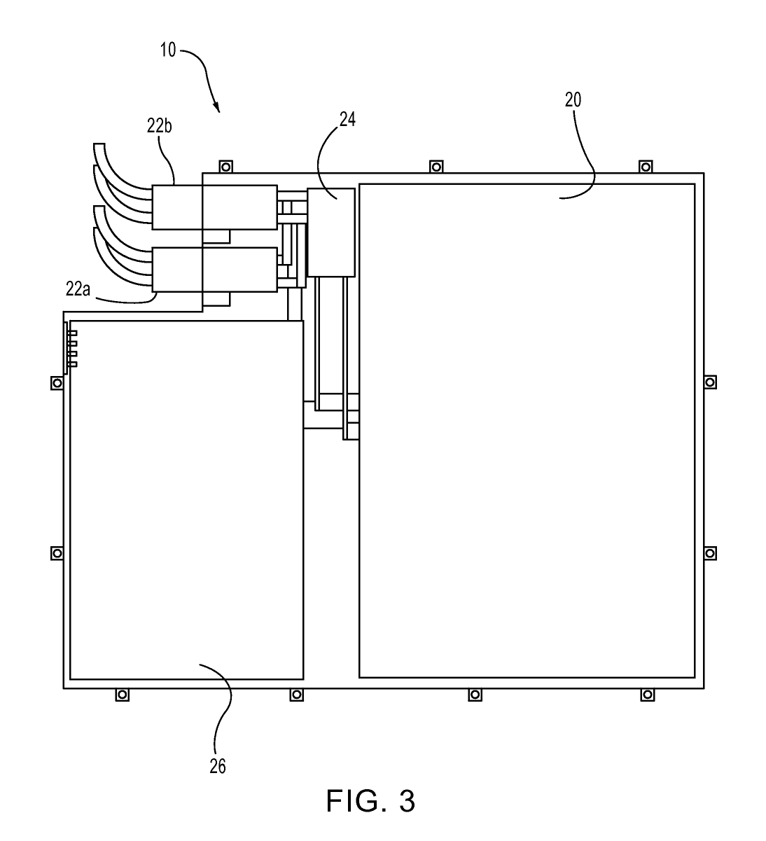

FIG. 3 is a top view of the internal components of the capacitor system 10 shown in FIG. 2. The capacitor system 10 includes an EDLC bank 20 (similar to capacitor bank 130) and two connectors 22a, 22b (similar to connectors 108, 109) to connect the capacitor system 10 to the vehicle's conventional battery system. The use of two connectors 22a and 22b eliminates the need to modify one connector which makes installation quicker, easier, and accomplishes the same task as a single connector. A main disconnect sensing switch 24 also is included to prevent the capacitor system 10 from discharging in the event that one or both of the forklift truck or battery connectors are disconnected. The capacitor system 10 also includes a control module 26 that monitors the status of the electronic/power system and controls the charging and discharging of the EDLC bank 20. The control module 26 can be structurally and functionally similar to the control module 110, shown and described above.

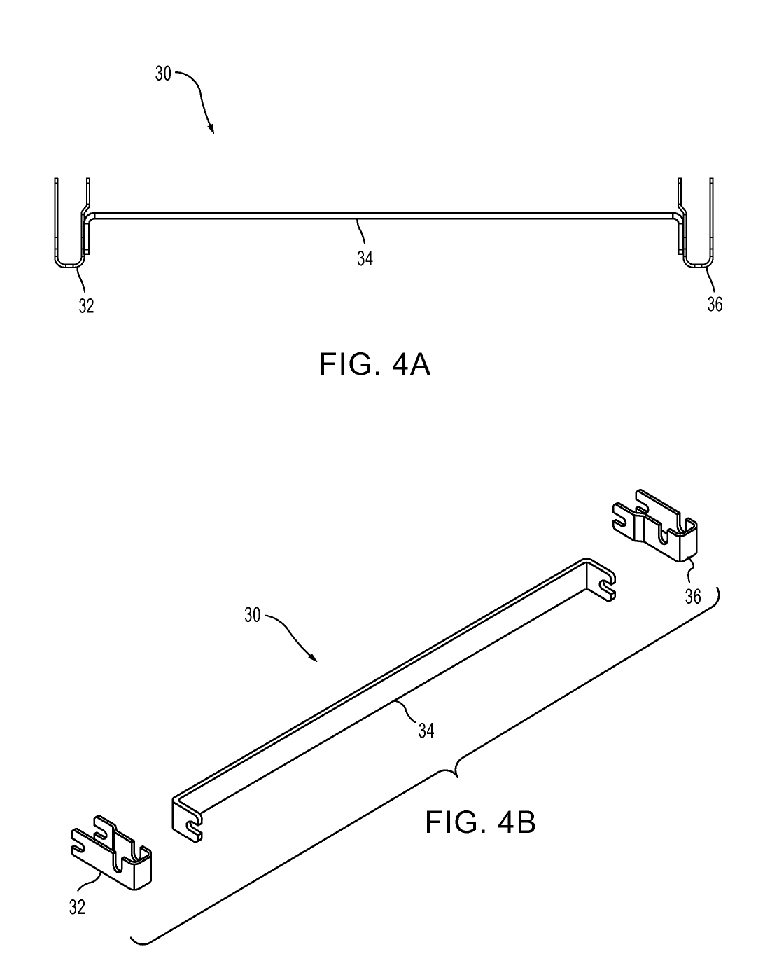

FIGS. 4A and 4B illustrate a bus bar assembly 30 used to assemble the EDLC bank 20. The bus bar assembly 30 includes a left side C-connector 32, a bus bar 34, and a right side C-connector 36. The C-connectors 32, 36 and bus bar 34 has holes or slots that allow screws to pass through to secure the bus bar assembly 30 to individual EDLC terminals.

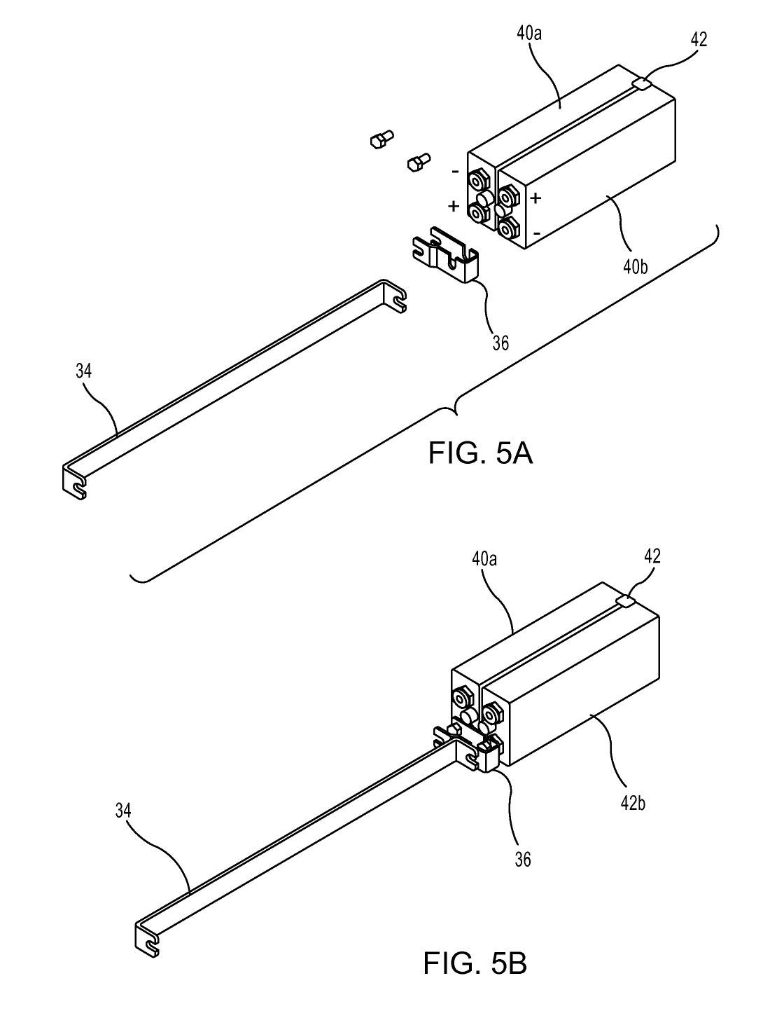

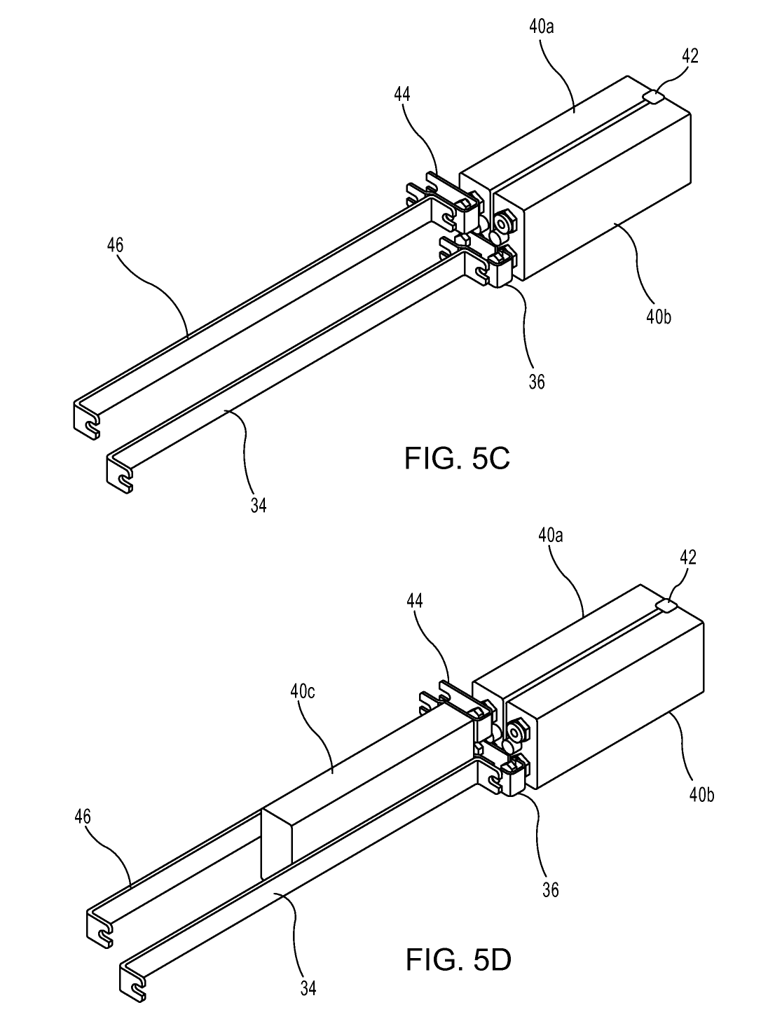

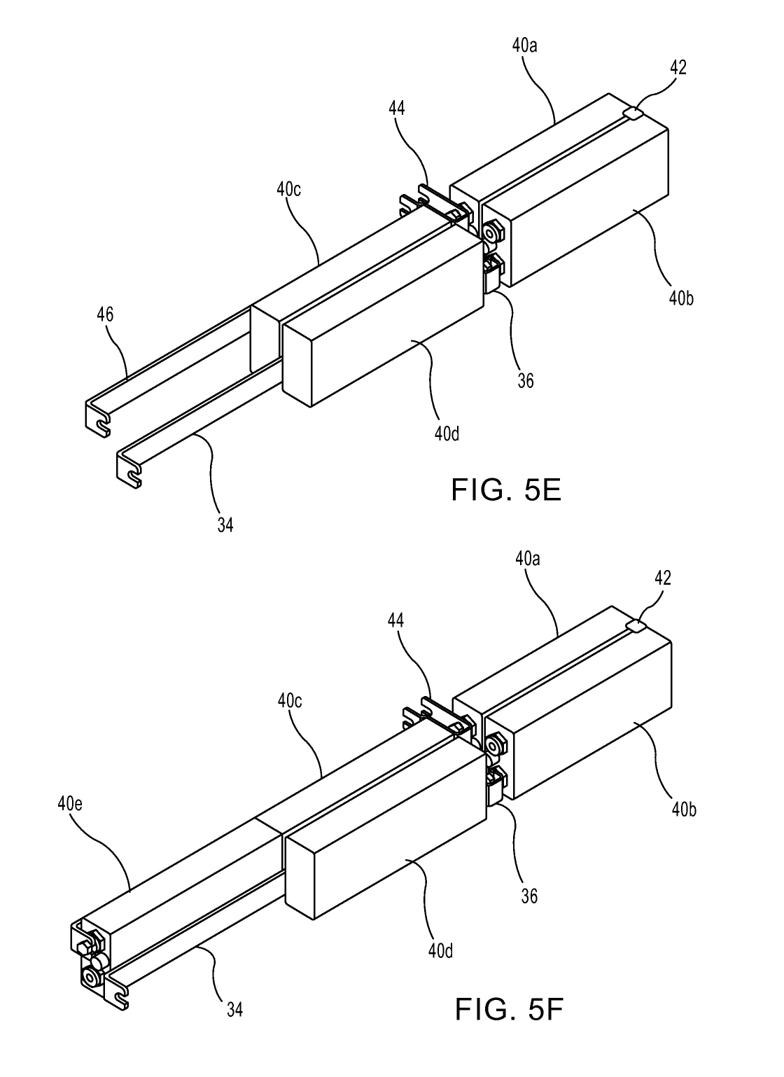

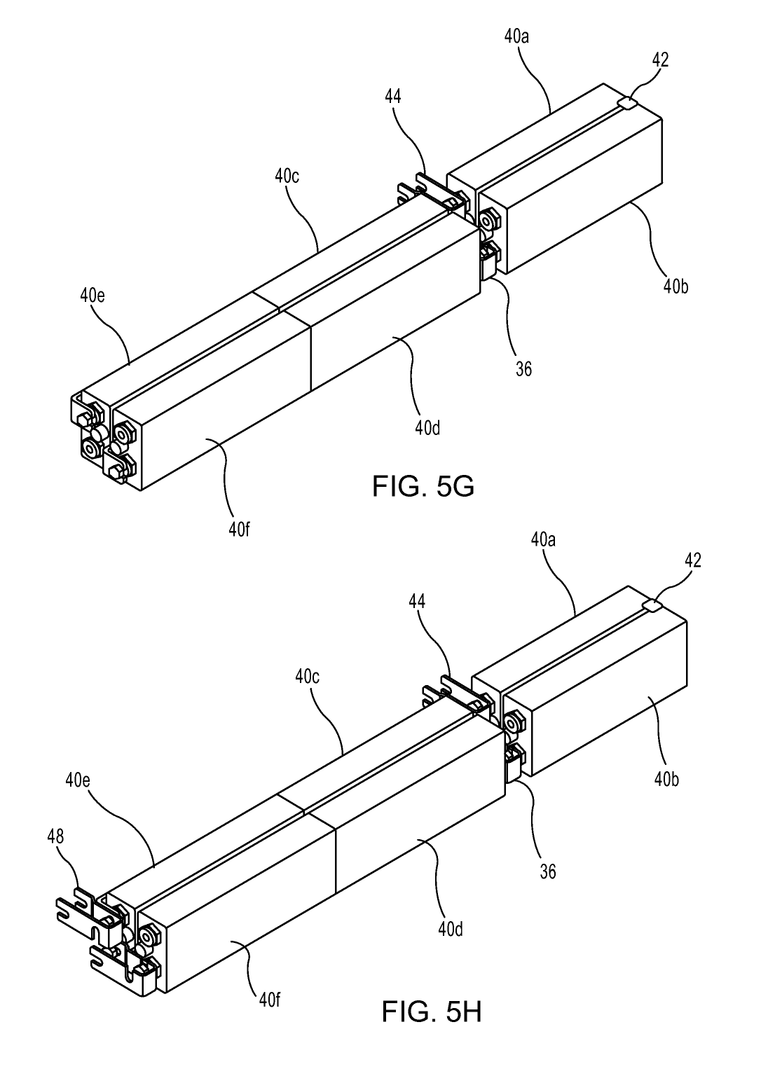

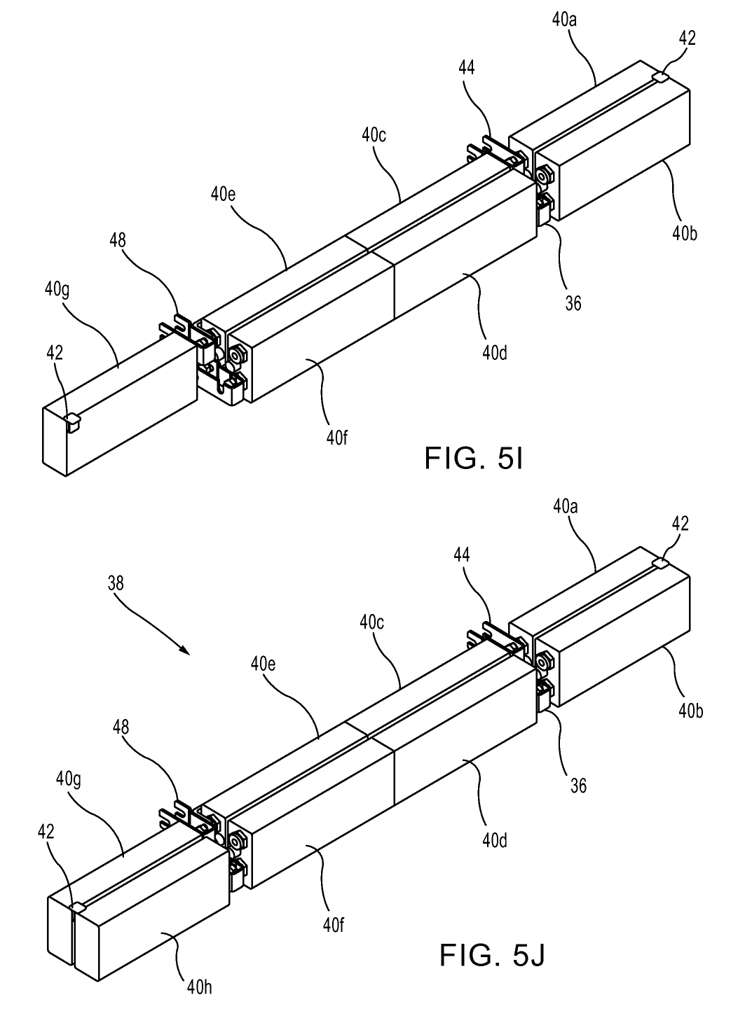

FIGS. 5A-5J depict an example of how an eight cell EDLC bank 38 using the bus bar assemblies 30 shown in FIGS. 4A and 4B can be assembled. Two EDLCs are positioned adjacent each other with terminals having opposite polarity next to each other. For example, in FIG. 5A, the first EDLC 40a is positioned such that its negative pole is disposed adjacent the positive pole of the second EDLC 40b and its positive pole is disposed adjacent the negative pole of the second EDLC 40a. A right side C-connector 36 is attached to the two EDLCS 40a, 40b with screws, bolts, or other mechanical fasteners (see FIG. 5B). A bus bar 34 is also positioned but is not connected to the C-connector 36 or to the EDLCS 40a, 40b. Additionally, the EDLCs 40a, 40b can be held apart with one or more spacers 42.

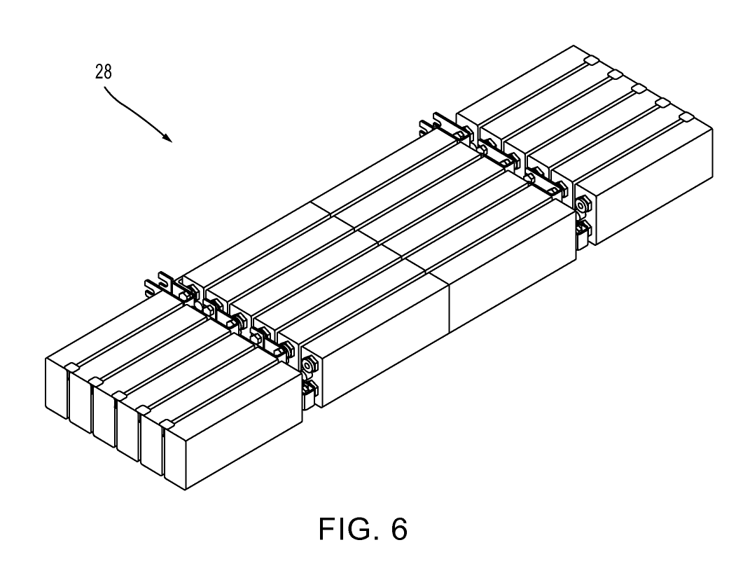

Referring now to FIGS. 5C and 5D, a second right side C-connector 44 is attached to one of the EDLCs 40a, and a second bus bar 46 is positioned but not yet attached. A third EDLC 40c is positioned such that it faces the first EDLC 40a and attached to the right side C-connectors 36, 44 and to the second bus bar 46 with screws, bolts, or other mechanical fasteners. FIGS. 5E-5J illustrate the successive addition of EDLCs 40d, 40e, 40f, 40g, 40h using left side C-connectors, right side C-connectors, bus bars, and screws until an eight cell EDLC bank 38 is fully assembled. As shown in FIG. 5J, two C-connectors 44, 48 protruded out from the eight cell EDLC bank 38 allowing additional eight cell EDLC banks to be connected to create higher voltage EDLC banks. For example, FIG. 6 illustrates a twenty-four cell, EDLC bank 28.

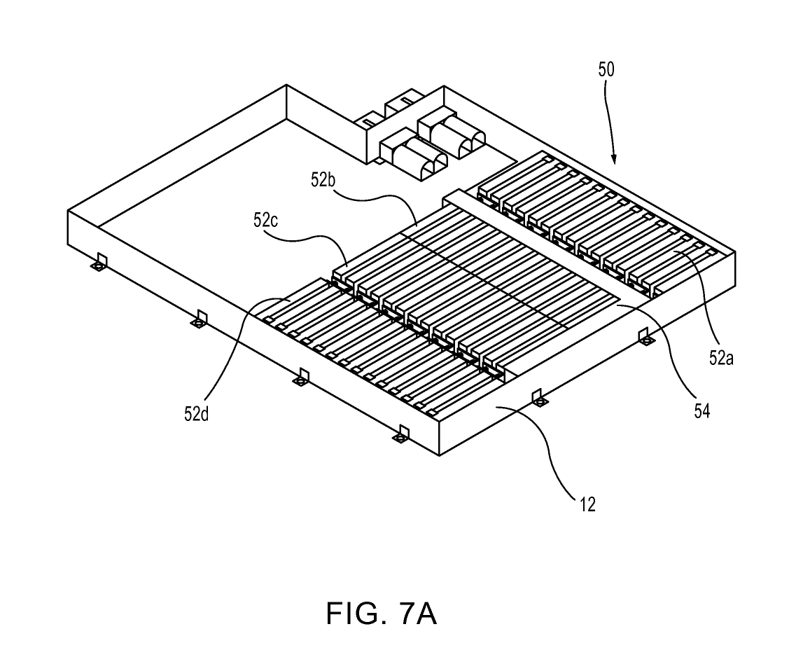

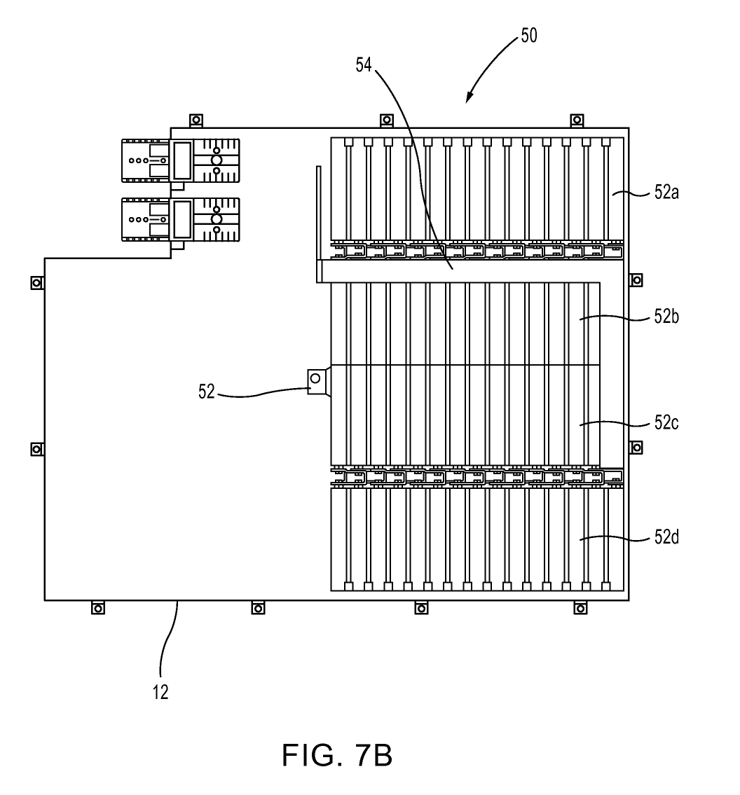

Referring now to FIGS. 7A and 7B, a 60 cell EDLC bank 50 is shown fully assembled and installed in a housing 12. The bank 50 includes four rows of EDLCs 52a, 52b, 52c, 52d of fifteen individual EDLCs per row and is assembled with bus bar assemblies 30 as described above. The EDLCs within each row of EDLCs 52a, 52b, 52c, 52d are coupled to each other in series. The EDLC rows 52a, 52b, 52c, 52d are coupled to each other in parallel. The EDLC bank 50 configuration as shown provides spacing between the EDLCs for thermal design, structural support, cell balancing, reduced series resistance, space savings, and a substantial reduction in parts used. The EDLC bank 50 also includes a high side bus bar 52 and a low side bus bar 54 to electrically connect the EDLC bank 50 to other electronics and/or power systems.

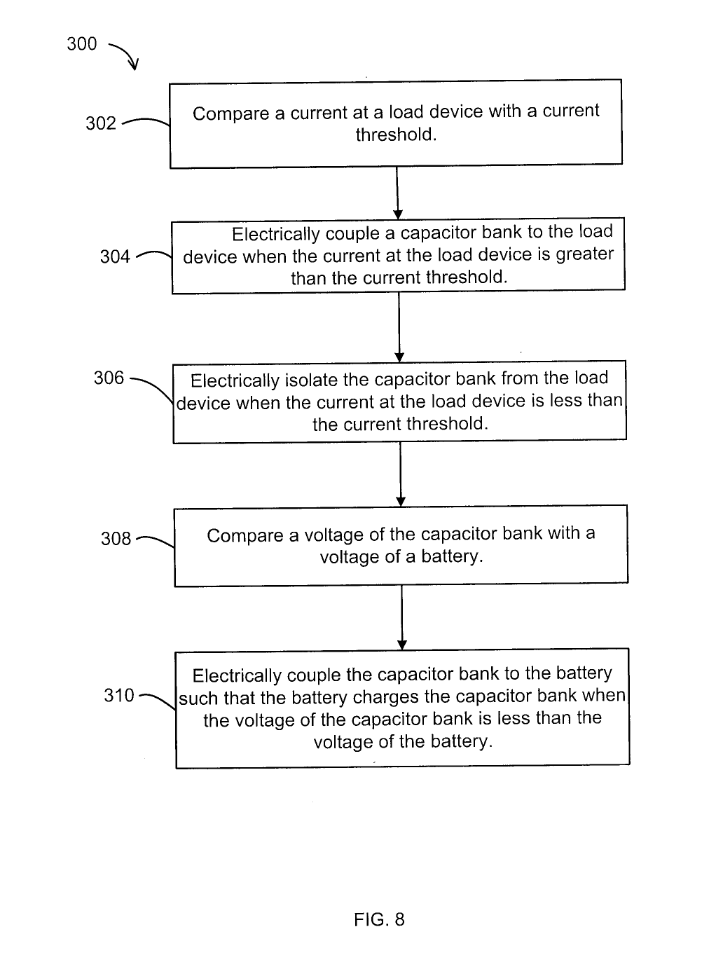

FIG. 8 is a flow chart illustrating a method 300 of controlling a power system. The method 300 includes comparing a current at a load device with a current threshold, at 302. In some embodiments, for example, a control module (e.g., control module 110 shown and described with respect to FIG. 1A) monitors the current at the load device.

A capacitor bank is electrically coupled to the load device when the current at the load device is greater than the current threshold, at 304. In some embodiments, the control module sends a first control signal to a switch (e.g., a MOSFET). The switch can be configured to electrically couple the capacitor bank to the load device (e.g., complete a circuit and/or current loop between the capacitor bank and the load device) in response to receiving the first control signal. In such embodiments, the capacitor bank and a battery can collectively provide power to the load device. As discussed above, this can reduce the stress on the battery.

The capacitor bank is electrically isolated from the load device when the current at the load device is less than the current threshold, at 306. In some embodiments, the control module sends a second control signal to the switch. The switch can be configured to electrically isolate the capacitor bank from the load device (e.g., break a circuit and/or current loop between the capacitor bank and the load device) in response to receiving the second control signal. In such embodiments, when the current at the load device is less than the current threshold, the battery can be the sole source of power to the load device.

A voltage of the capacitor bank is compared with a voltage of a battery, at 308. The capacitor bank is electrically coupled to the battery such that the battery charges the capacitor bank when the voltage of the capacitor bank is less than the voltage of the battery, at 310. In such embodiments, the capacitor bank can be recharged such that it can help supply power to the load device if the current of the load device becomes greater than the current threshold.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

Some embodiments described herein relate to a computer storage product with a computer- or processor-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as general purpose microprocessors, microcontrollers, Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

Although various embodiments have been described as having particular features and/or combinations of components, other embodiments are possible having a combination of any features and/or components from any of embodiments where appropriate. For example, a capacitor bank can include any number of capacitors arranged in any configuration (series, parallel, or series-parallel).

What is claimed is:

1. A system, comprising:
a battery electrically coupled to a load device, the battery configured to supply power to the load device when the system is in a first configuration, the system being in the first configuration when a current requirement of the load device is less than a current threshold; and
a capacitor bank including a plurality of capacitors, the capacitor bank being electrically coupled to the battery when the system is in a second configuration, the battery and the capacitor bank being configured to collectively provide power to the load device when the system is in the second configuration, the system being in the second configuration when the current requirement of the load device is greater than the current threshold.

2. The system of claim 1, wherein the capacitor bank includes a plurality of capacitor rows coupled to each other in a parallel configuration, each capacitor row from the plurality of capacitor rows including a plurality of capacitors coupled to each other in a series configuration.

3. The system of claim 1, wherein the battery is configured to charge the plurality of capacitors when the system is in a third configuration, the system being in the third configuration when a voltage associated with the capacitor bank is less than a voltage associated with the battery.

4. The system of claim 1, wherein the capacitor bank is electrically isolated from the load device when the battery is electrically isolated from the load device.

5. The system of claim 1, wherein each capacitor from the plurality of capacitors is an EDLC.

6. The system of claim 1, wherein the battery is configured to charge the plurality of capacitors when the system is in a third configuration, the system being in the third configuration when a voltage associated with the capacitor bank is less than a voltage associated with the battery, a current supplied to the capacitor bank from the battery being less than a charging current threshold.

7. The system of claim 1, wherein the capacitor bank is electrically isolated from the load device when a voltage associated with the battery is greater than a voltage threshold.

8. The system of claim 1, wherein the capacitor bank is electrically isolated from the load device when a voltage associated with the battery is less than a voltage threshold.

9. The system of claim 1, wherein the battery is the sole source of power to the load device when the system is in the first configuration.

10. The system of claim 1, wherein the capacitor bank is electrically isolated from the load device when the system is in the first configuration.

11. A processor-readable medium storing code representing instructions configured to cause a processor to:
electrically isolate a capacitor bank of a system from a load device of the system when the system is in a first configuration, a battery of the system providing power to the load device when the system is in the first configuration, the system being in the first configuration when a current requirement of the load device is less than a current threshold;
electrically couple the capacitor bank of the system to the load device of the system when the system is in a second configuration, the battery of the system and the capacitor bank of the system collectively providing power to the load device when the system is in the second configuration, the system being in the second configuration when a current requirement of the load device is greater than a current threshold; and
electrically couple the capacitor bank with the battery such that the battery charges the capacitor bank when the system is in a third configuration, the system being in the third configuration when a voltage associated with the capacitor bank is less than a voltage associated with the battery.

12. The processor-readable medium of claim 11, wherein the capacitor bank includes a plurality of capacitor rows coupled to each other in a parallel configuration, each capacitor row from the plurality of capacitor rows including a plurality of capacitors coupled to each other in a series configuration.

13. The processor-readable medium of claim 11, the code further comprising code representing instructions to cause a processor to:
electrically isolate the capacitor bank from the load device when the battery is electrically isolated from the load device.

14. The processor-readable medium of claim 11, wherein each capacitor from the plurality of capacitors is an EDLC.

15. The processor-readable medium of claim 11, wherein, a current supplied to the capacitor bank from the battery when the system is in the third configuration is less than a charging current threshold of the battery.

16. The processor-readable medium of claim 11, the code further comprising code representing instructions to cause a processor to:
electrically isolate the capacitor bank from the load device when the voltage associated with the battery is greater than a voltage threshold.

17. The processor-readable medium of claim 11, the code further comprising code representing instructions to cause a processor to:
electrically isolate the capacitor bank from the load device when the voltage associated with the battery is less than a voltage threshold.

18. A method, comprising:
comparing a current at a load device with a current threshold;
electrically coupling a capacitor bank to the load device when the current at the load device is greater than the current threshold;
electrically isolating the capacitor bank from the load device when the current at the load device is less than the current threshold;
comparing a voltage of the capacitor bank with a voltage of a battery; and
electrically coupling the capacitor bank to the battery such that the battery charges the capacitor bank when the voltage of the capacitor bank is less than the voltage of the battery.

19. The method of claim 18, wherein the electrically coupling the capacitor bank to the load device includes sending a control signal operative to electrically couple the capacitor bank to the load device.

20. The method of claim 18, further comprising:
comparing the voltage of the battery with a threshold voltage; and
electrically isolating the capacitor bank from the load device when the voltage of the battery is greater than the threshold voltage.

21. The method of claim 18, further comprising:
comparing the voltage of the battery with a threshold voltage; and
electrically isolating the capacitor bank from the load device when the voltage of the battery is less than the threshold voltage.

22. The method of claim 18, further comprising:
electrically isolating the capacitor bank from the load device when the battery is electrically isolated from the load device.

23. The method of claim 18, further comprising:
limiting an amount of current supplied to the capacitor bank from the battery when the capacitor bank is electrically coupled to the battery.
